(19) United States
(12) Patent Application Publication
(10) Pub. No.: US 2006/0096708 A1
(43) Pub. Date: May 11, 2006

(54) System for producing rolls of air-filled cushioning material

(75) Inventor: William Morris Robinson, Palo Alto, CA (US)

Correspondence Address: EDWARD S. WRIGHT, 1100 ALMA STREET, SUITE 207, MENLO PARK, CA, 94025, US

(73) Assignee: Free-Flow Packaging International, Inc.

(21) Appl. No.: 10/982,600

(22) Filed: Nov. 5, 2004

(51) Int. Cl. B65B 31/00; B32B 37/00; B67B 3/24

(52) U.S. Cl. 156/352; 53/403; 156/494

(57) ABSTRACT

System for producing rolls of air-filled cushioning material which includes a machine for inflating and sealing a preconfigured film material to form a continuous sheet of air-filled cushioning material, and a winder having a spindle for receiving the inflated cushioning material from the machine, a drive motor for rotating the spindle to wind the inflated cushioning material into a roll on the spindle, a feeler arm in peripheral engagement with the roll of inflated cushioning material for monitoring the diameter of the roll, and means responsive to the feeler arm for controlling the motor in accordance with the diameter of the roll to maintain substantially uniform tension in the material as the material is wound into the roll.

### BACKGROUND OF THE INVENTION

1. Field of Invention

This invention pertains generally to cushioning and packing materials and, more particularly, to a system for producing relatively large rolls of air-filled cushioning material.

2. Related Art

In recent years, air-filled packing materials have come into wide use as a cushioning material or void filler in shipping cartons and the like. The earliest such material to find wide acceptance was probably the material commonly known as bubble wrap which comes in the form of plastic sheets sealed together to form a number of relatively small, individual air-filled cells. Those materials are usually stored and shipped in an inflated state, which is not efficient.

More recently, air filled packing and cushioning materials have been provided in an uninflated, but preconfigured form which can be inflated and sealed at the location or site where they are to be used. Such materials are relatively compact and are typically formed into rolls or stacked into boxes for shipment and storage. They come in a variety of different forms, including relatively large, individual cushions and sheets having rows of smaller, interconnected cells. The communication between the cells in a row is advantageous in that it permits the air to shift from between cells to absorb impact loads as well as permitting the material to conform more closely to the contours of objects wrapped in it. Examples of such materials are found in U.S. Pat. Nos. 6,410,119 and 6,761,960. Copending application Ser. No. 10/929,353 discloses a high speed machine which can produce wider sheets of cellular material than had been possible with other machines.

While smaller cushions are conveniently collected and stored in bins until they are used, larger sheets of cushioning materially are generally wound into rolls for distribution and storage. Winding machines heretofore provided for that purpose have been subject to certain limitations and disadvantages such as lack of reliable speed control and dependence on slip clutches for speed control and safety.

### OBJECTS AND SUMMARY OF THE INVENTION

It is, in general, an object of the invention to provide a new and improved system for producing rolls of air-filled cushioning material.

Another object of the invention is to provide a machine of the above character which overcomes the limitations and disadvantages of machines heretofore provided.

These and other objects are achieved in accordance with the invention by providing a system which includes a machine for inflating and sealing a preconfigured film material to form a continuous sheet of air-filled cushioning material, and a winder having a spindle for receiving the inflated cushioning material from the machine, a drive motor for rotating the spindle to wind the inflated cushioning material into a roll on the spindle, a feeler arm in peripheral engagement with the roll of inflated cushioning material for monitoring the diameter of the roll, and means responsive to the feeler arm for controlling the motor in accordance with the diameter of the roll to maintain substantially uniform tension in the material as the material is wound into the roll.

### BRIEF DESCRIPTION OF THE DRAWINGS

FIG. 1 is an isometric view of one embodiment of a system for producing rolls of air-filled cushioning material in accordance with the invention.

FIG. 2 is an elevational view of the winding machine in the embodiment of FIG. 1.

FIG. 3 is a fragmentary elevational view of drive motor and pulleys in the winding machine in the embodiment of FIG. 1.

FIG. 4 is a fragmentary isometric view of the control mechanism in the winding machine in the embodiment of FIG. 1.

### DETAILED DESCRIPTION

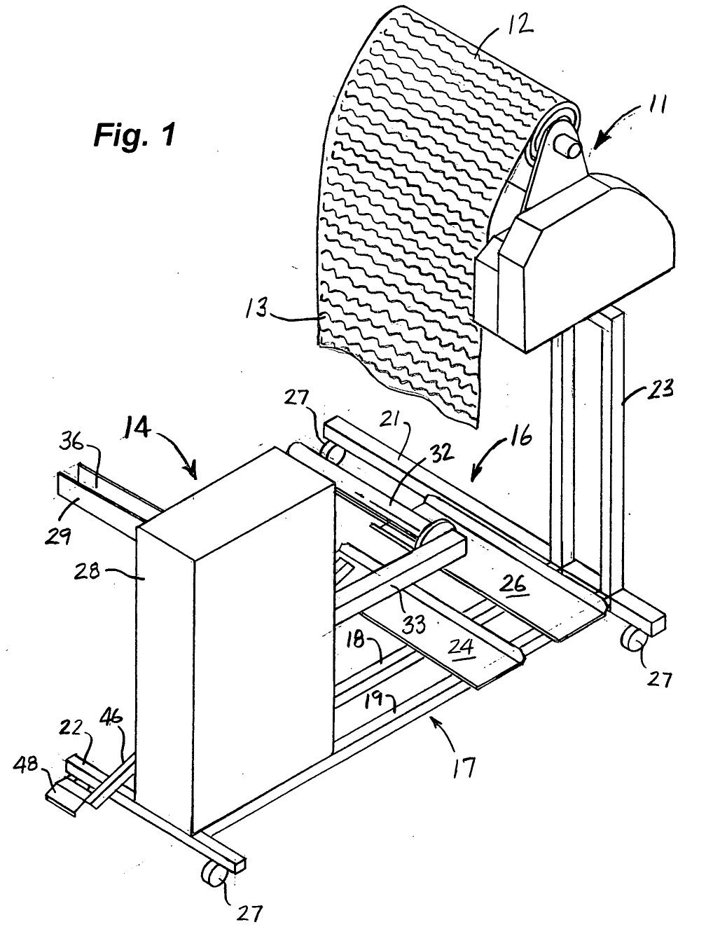

As illustrated in FIG. 1, the system includes a machine 11 for inflating and sealing a preconfigured film material 12 to form a continuous sheet 13 of air-filled cushioning material, a winding machine 14 for winding the inflated material into a roll, and a cart 16 on which the two machines are mounted.

The machine for inflating and sealing the film material can, for example, be of the type disclosed in copending application Ser. No. 10/929,353, the disclosure of which is incorporated herein by reference. That machine uses a film material which has two layers of a suitable plastic material such as polyethylene that are sealed together to form a longitudinally extending inflation channel along one edge of the material and rows of interconnected, inflatable cells which extend laterally across the material. Inlet passageways interconnect the inflation channel and the first cell in each of the rows, and relatively narrow passageways interconnect adjacent cells within the rows. The rows of cells are formed by undulating seal lines which are offset from each other such that the flow passageways in one row are adjacent to the cells in the rows on either side of it, and the adjacent cells and passageways are formed by common seals with no dead space between them. Rows of perforations extend across the material a periodic intervals to facilitate tearing the material into desired lengths for use.

The machine engages the edge portion of the material near the inflation channel and feeds the material along an inflation tube which extends into the inflation channel and injects air into the cells. It then seals the material across the inlet passageways to retain the air in the cells.

The cart has a horizontally extending frame or base 17 with longitudinally extending rails 18, 19 and cross members 21, 22. Inflating and sealing machine 11 is mounted on a stand 23 at one end of the base, and winding machine 14 rests upon rails toward the other. A pair of laterally extending trays 24, 26 are mounted on the rails between the two machines for holding spare rolls of the preconfigured film material. Casters or wheels 27 are mounted on the under sides of cross members 21, 22 and permit the system to be moved readily from one location to another.

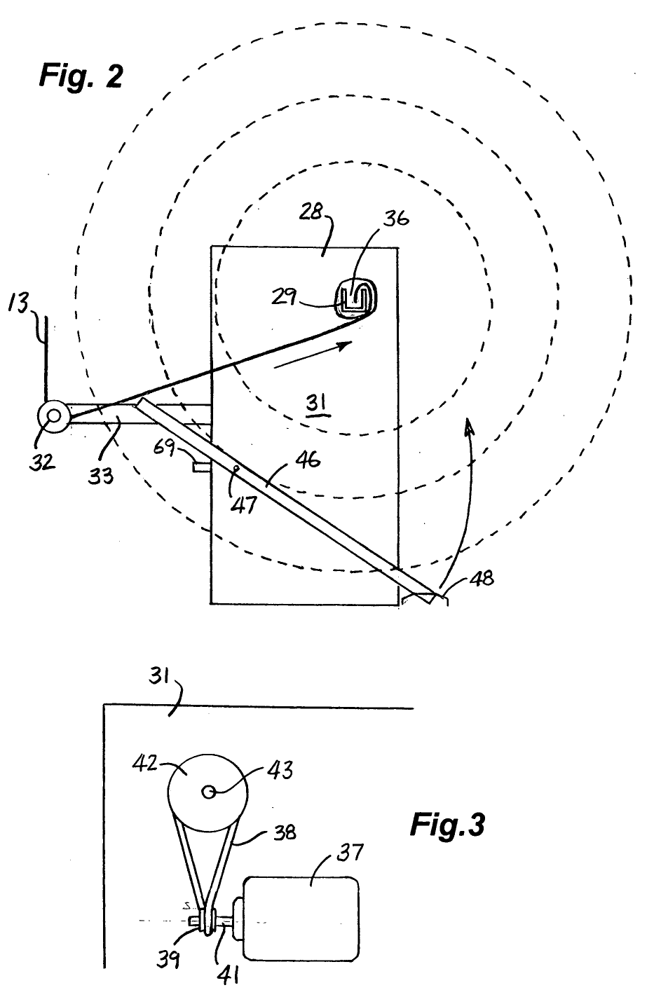

The winding machine has a generally rectangular housing or base 28, with a spindle 29 for receiving the inflated cushioning material and winding it into a roll. The spindle extends horizontally from a side wall 31 of the housing and in a direction generally parallel to the supply roll 12 on the inflating and sealing machine. A horizontally extending guide roller 32 is mounted on an arm 33 which extends from an end wall 34 of the housing toward the inflating and sealing machine. As best seen in FIG. 2, the inflated cushioning material is discharged in a downward direction from the inflating and sealing machine and is trained about the under side of the guide roller before being wound onto the spindle.

In the embodiment illustrated, spindle 29 has a generally U-shaped cross section that defines a channel 36 into which the end portion of the inflated cushioning material can be stuffed to hold the material on the spindle as the winding process begins.

As illustrated in FIG. 3, the spindle is rotated about its axis by a drive motor 37 which is mounted on the inner side of housing wall 31, with a drive belt 38 trained about a drive pulley 39 on motor shaft 41 and a driven pulley 42 on spindle shaft 43. The two shafts and, hence, the pulleys mounted on them are perpendicular to each other, and the drive belt is twisted as it passes between them. The belt has a circular cross section, and the combination of that cross section and the twisting of the belt have been found to be surprisingly effective both in maintaining good control over the roll as the material is wound onto it and in permitting slippage in the event that rotation of the spindle is impeded, e.g. if the hand of an operator should get caught in the roll.

Means is provided for monitoring the diameter of the roll and adjusting the speed of the motor to maintain uniform tension in the material as it is wound onto the roll. This means includes a dancer arm 46 which is mounted on a shaft 47 for rotation about a pivot axis, with a feeler 48 at the lower end of the arm which is urged into peripheral engagement with the roll by suitable means such as a torsion spring 49, weights on the upper portion the arm, or a combination of thereof.

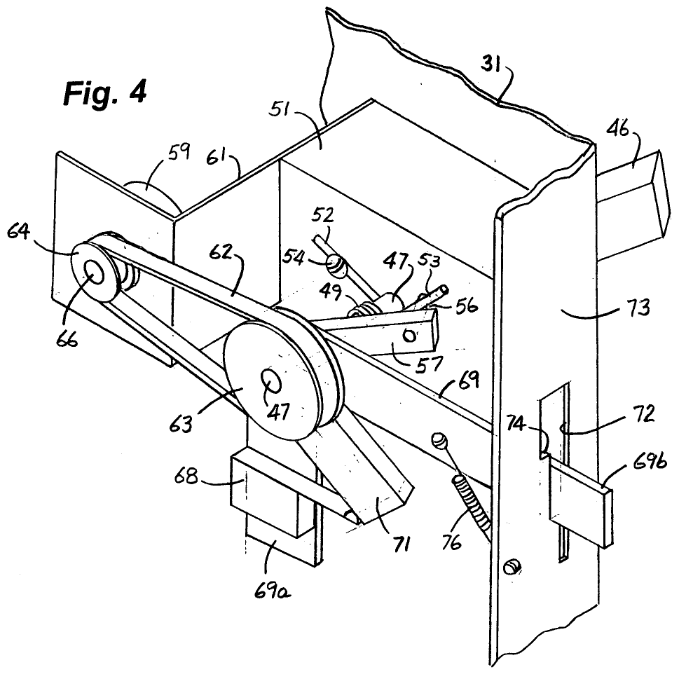

As illustrated in FIG. 4, dancer arm shaft 47 is rotatively mounted in a bearing block 51 on the inner side of housing wall 31. Torsion spring 49 is disposed coaxially of the shaft, with the arms 52, 53 of the spring bearing against a screw 54 on the bearing block and a pin 56 carried by an arm 57 affixed to the shaft.

The position of the dancer arm is monitored by a potentiometer 59 mounted on a bracket 61 attached to bearing block 51. The potentiometer is driven by a belt 62 trained about pulleys 63, 64 which are affixed to shaft 47 and to the shaft 66 of the potentiometer. The potentiometer is connected to a motor controller which increases the power applied to drive motor 37, and hence the speed of the motor, as the diameter of the roll increases.

Means is also provided for shutting the motor down when the roll reaches a predetermined diameter. This means includes a micro switch 68 mounted on one leg 69a of an L-shaped control arm 69 which is pivotally mounted on shaft 47 and actuated by a radially extending cam 71 affixed to the shaft. The other leg of the control arm extends through an opening 72 in the end wall 73 of enclosure 28 and can be moved between different detent stops 74 to change the position of the micro switch relative to the cam. In the embodiment illustrated, three detent stops are provided, corresponding to roll diameters of 24, 36 and 48 inches. The control arm is urged into engagement with the detent steps by a coil spring 76 connected between the control arm and the wall of the enclosure, with the point of connection to the wall being below and to the rear of the connection to the arm.

Operation and use of the system is as follows. The film material is inflated and sealed by machine 11, then trained about the lower side of guide roller 32, with the end portion of the material being brought around the under side of spindle 29 and then stuffed into channel 36. Control lever 69 is set for the desired roll size, and drive motor 37 is turned on to rotate the spindle about its axis. As the material is discharged from the inflating and sealing machine, it is wound into a roll on the spindle, and the size of the roll is monitored by dancer arm 46 and feeler 48. As the diameter of the roll increases, potentiometer 59 signals the motor controller to increase the power to the motor to maintain uniform tension into the material being wound onto the roll. When the roll reaches the diameter set by control arm 69, micro switch 68 is actuated and signals the controller to remove the power from the motor.

In the event that something should impede the rotation of the spindle, motor belt 38 will slip until the obstruction is cleared.

The invention has a number of important features and advantages. It produces relatively large rolls of inflated cushioning material quickly and easily, and it permits the roll size to be selected in advance. Such rolls might, for example, have a length of 30 inches and a diameter of 24, 36 or 48 inches. The system maintains uniform tension in the material, which is important from the standpoint of maintaining control over the material and producing tight, well formed rolls, and it provides reliable speed control and safety without the use of slip clutches.

It is apparent from the foregoing that a new and improved system for producing rolls of air-filled cushioning material has been provided. While only certain presently preferred embodiments have been described in detail, as will be apparent to those familiar with the art, certain changes and modifications can be made without departing from the scope of the invention as defined by the following claims.

1. A system for producing a roll of inflated cushioning material, comprising: a cart, a machine on the cart for inflating and sealing a preconfigured film material to form a continuous sheet of air-filled cushioning material, and a winder on the cart having a spindle for receiving the inflated cushioning material from the machine, a drive motor for rotating the spindle to wind the inflated cushioning material into a roll on the spindle, a feeler arm in peripheral engagement with the roll of inflated cushioning material for monitoring the diameter of the roll, and means responsive to the feeler arm for controlling the motor in accordance with the diameter of the roll to maintain substantially uniform tension in the material as the material is wound into the roll.

2. The system of claim 1 wherein the means for controlling the motor includes means for increasing the speed of the motor as the diameter of the roll increases.

3. The system of claim 1 including means responsive to the feeler arm for stopping the motor when the roll reaches a predetermined diameter.

4. The system of claim 3 wherein the means for stopping the motor includes a switch which is actuated when the roll reaches the predetermined diameter.

5. The system of claim 4 wherein the switch is mounted on a selector for movement between different positions for actuation at different roll diameters.

6. A system for producing a roll of inflated cushioning material, comprising: a spindle, a motor for rotating the spindle to wind an elongated length of inflated cushioning material into a roll on the spindle, a pivotally mounted dancer arm, a feeler carried by the dancer arm for peripheral engagement with the roll of inflated cushioning material to move the arm to a position corresponding to the diameter of the roll, and means for monitoring the position of the dancer arm and applying more power to the motor as the diameter of the roll increases.

7. The system of claim 6 including a switch responsive to the position of the dancer arm for stopping the motor when the roll reaches a predetermined diameter.

8. The system of claim 6 including means for yieldably urging the feeler into engagement with the roll.

9. The system of claim 7 wherein the means for urging the feeler into engagement with the roll is selected from the group consisting of a counter-weight mounted on the dancer arm, a spring connected to the dancer arm and combinations thereof.

10. A system for producing a roll of inflated cushioning material, comprising: a base, a spindle rotatively mounted on the base upon which an elongated length of inflated cushioning material can be wound, means for rotating the spindle to wind the material into a roll, a dancer arm pivotally mounted on the base, a feeler carried by the dancer arm for peripheral engagement with the roll to move the arm to a position corresponding to the diameter of the roll, means responsive to the position of the dancer arm for controlling rotation of the spindle to maintain a substantially uniform tension in the material wound onto the roll as the diameter of the roll increases, and means for stopping the rotation of the spindle when the roll reaches a predetermined diameter.

11. The system of claim 10 wherein the means for rotating the spindle comprises a drive motor having an output shaft perpendicular to the spindle, a drive pulley on the motor shaft, a driven pulley on the spindle, and a drive belt trained about the pulleys.

12. The system of claim 11 wherein the drive belt has a circular cross section and is adapted to slip on the pulleys if rotation of the roll is resisted.

13. The system of claim 10 wherein the spindle has a generally U-shaped cross section with a trough into which an end portion of the inflated cushioning material can be stuffed to engage the material with the spindle.

14. The system of claim 10 wherein the means for rotating the spindle comprises an electrically energized drive motor, and the means for controlling the rotation of the roll includes a variable resistive element driven by the dancer arm for controlling the amount of electrical power to applied to the motor so that more power is applied to the motor as the diameter of the roll increases.

15. The system of claim 10 wherein the means for rotating the spindle comprises an electrically energized motor, and the means for stopping the rotation of the roll includes a switch for de-energizing the motor.

16. The system of claim 15 wherein the switch is mounted on a selector which can be set in different positions corresponding to different roll diameters,

17. A system for producing a roll of inflated cushioning material, comprising: a base, a spindle mounted on the base for rotation about an axis, a drive motor, a drive pulley and a driven pulley connected to the drive motor and the spindle for rotation about mutually perpendicular axes, a drive belt of circular cross section trained about the pulleys, means for monitoring the diameter of a roll of inflated cushioning material wound about the spindle, and means responsive to the diameter of the roll for controlling operation of the motor.

18. The system of claim 17 wherein the means for controlling operation of the motor includes means for increasing the speed of the motor to maintain substantially uniform tension in the material winding onto the roll as the diameter of the roll increases.

19. The system of claim 17 wherein the means for controlling operation of the motor includes means for stopping the motor when the roll reaches a predetermined diameter.
